(19) United States
(12) Patent Application Publication
(10) Pub. No.: US 2010/0301509 A1
(43) Pub. Date: Dec. 2, 2010

(54) COATING COMPOSITION FOR FOAM PARTICLES, AND METHOD FOR THE PRODUCTION OF MOLDED FOAM BODIES

(75) Inventors: Benjamin Nehls, Ludwigshafen (DE); Klaus Hahn, Kirchheim (DE); Andreas Keller, Bohl-Iggelheim (DE); Bernhard Schmied, Frankenthal (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/677,994

(22) PCT Filed: Sep. 3, 2008
(86) PCT No.: PCT/EP2008/061636

§ 371 Date: Mar. 12, 2010

(30) Foreign Application Priority Data
Sep. 14, 2007 (EP) 07116454.5
Jun. 16, 2008 (EP) 08158327.0

(51) Int. Cl. B29C 44/02; C08K 3/34; B29C 45/00

(52) U.S. Cl. 264/41; 524/445; 524/447; 521/91; 521/56; 264/109

(57) ABSTRACT

The invention relates to a coating composition comprising

a) from 20 to 70% by weight, in particular from 30 to 50% by weight, of a clay mineral,
b) from 20 to 70% by weight, in particular from 30 to 50% by weight, of an alkali metal silicate,
c) from 1 to 30% by weight, in particular from 5 to 20% by weight, of a film-forming polymer,
and also to a process for producing coated foam particles and foam moldings produced therefrom and their use.

The invention relates to a coating composition, a process for producing coated foam particles and also foam moldings produced therefrom and their use.

Particle foams are usually obtained by sintering foam particles, for example prefoamed expandable polystyrene particles (EPS) or expanded polypropylene particles (EPP), in closed molds by means of steam.

Polystyrene foams having a low flammability are generally provided with halogen-comprising flame retardants such as hexabromocyclododecane (HBCD). However, their permitted use as insulation materials in the building sector is restricted to particular applications. The reason for this is, inter alia, the melting and dripping of the polymer matrix in the case of fire. In addition, the halogen-comprising flame retardants are not able to be used without restriction because of their toxicological properties.

WO 00/050500 describes flame-resistant foams made of prefoamed polystyrene particles which are mixed with an aqueous sodium silicate solution and a latex of a high molecular weight vinyl acetate copolymer, poured into a mold and dried in air while shaking. This gives only a loose bed of polystyrene particles which are conglutinated at only a few points and therefore have only unsatisfactory mechanical strengths.

WO 2005/105404 describes an energy-saving process for producing foam moldings, in which the prefoamed foam particles are coated with a resin solution which has a softening temperature lower than that of the expandable polymer. The coated foam particles are subsequently fused in a mold with application of external pressure or by after-expansion of the foam particles by means of hot steam.

WO 2005/07331 describes expanded polystyrene foam particles having a functional coating which is applied by means of a solvent which attacks the polystyrene foam particles to only a small extent. To provide a flame retardant coating, the surface can, for example, be coated with a methanolic polyvinyl acetate solution comprising aluminum hydroxide particles. To prevent conglutination during removal of the solvent, the particles have to be sprayed with a release liquid, for example ethylene glycol.

If the coated foam particles are used in conventional automatic molding machines, water-soluble constituents can be leached out when steam is used.

WO 2007/023089 describes a process for producing foam moldings from prefoamed foam particles which have a polymer coating. A mixture of a water glass solution, water glass powder and a polymer dispersion is used as preferred polymer coating. If appropriate, hydraulic binders based on cement or metal salt hydrates, for example aluminum hydroxide, can be added to the polymer coating.

A similar process is described in the as yet unpublished EP application No. 6122127 in which the coated foam particles can be dried and subsequently processed to produce fire- and heat-resistant foam moldings.

Hydraulic binders such as cement set even at room temperature in an aqueous slurry in the presence of carbon dioxide. Embrittlement of the foam board can occur as a result. In addition, the foam boards produced according to the prior art cited are not stable in the case of fire at temperatures above 800° C. and collapse in the case of fire.

It was an object of the present invention to remedy the disadvantages mentioned and to discover a coating composition for foam particles which makes it possible to process the coated foam particles to produce halogen-free, fire- and heat-resistant foam moldings. The coating should, in particular, not lead to embrittlement of the foam moldings and ensure the structural integrity of the foam moldings even at temperatures above 800° C.

We have accordingly found a coating composition comprising
a) from 20 to 70% by weight, in particular from 30 to 50% by weight, of a clay mineral,
b) from 20 to 70% by weight, in particular from 30 to 50% by weight, of an alkali metal silicate,
c) from 1 to 30% by weight, in particular from 5 to 20% by weight, of a film-forming polymer.

A preferred coating composition comprises
a) from 30 to 50% by weight, in particular from 35 to 45% by weight, of a clay mineral,
b) from 30 to 50% by weight, in particular from 35 to 45% by weight, of an alkali metal silicate,
c) from 5 to 20% by weight, in particular from 7 to 15% by weight, of a film-forming polymer,
d) from 5 to 40% by weight, in particular from 10 to 30% by weight, of an infrared-absorbing pigment.

The preceding amounts relate in each case to solids based on solids of the coating composition. Preferably, the components a) to c) or a) to d), respectively, add up to 100% by weight.

The weight ratio of clay mineral to alkali metal silicate in the coating composition is preferably in the range from 1:2 to 2:1.

Suitable clay minerals are, in particular, minerals comprising allophane Al₂[SiO₅]&O₃.nH₂O, kaolinite Al₄[(OH)₈|Si₄O₁₀], halloysite Al₄[(OH)₈|Si₄O₁₀].2H₂O, montmorillonite (smectite) (Al,Mg,Fe)₂[(OH₂|(Si,Al)₄O₁₀].Na_{0.33}(H₂O)₄, vermiculite Mg₂(Al,Fe,Mg)[(OH₂|(Si,Al)₄O₁₀].Mg_{0.35}(H₂O)₄ or mixtures thereof. Particular preference is given to using kaolin.

As alkali metal silicate, preference is given to using a water-soluble alkali metal silicate having the composition M₂O(SiO₂)ₙ where M=sodium or potassium and n=1 to 4 or mixtures thereof.

In general, the coating composition comprises an uncrosslinked polymer which has one or more glass transition temperatures in the range from −60° to +100° C. as film-forming polymer. The glass transition temperatures of the dried polymer film are preferably in the range from −30° to +80° C., particularly preferably in the range from −10° to +60° C. The glass transition temperature can be determined by means of differential scanning calorimetry (DSC, in accordance with ISO 11357-2, heating rate 20 K/min). The molecular weight of the polymer film determined by gel permeation chromatography (GPC) is preferably below 400 000 g/mol.

The coating composition preferably comprises an emulsion polymer of ethylenically unsaturated monomers, for example vinylaromatic monomers such as α-methylstyrene, p-methylstyrene, ethylstyrene, tert-butylstyrene, vinylstyrene, vinyltoluene, 1,2-diphenylethylene, 1,1-diphenylethylene, alkenes such as ethylene or propylene, dienes such as 1,3-butadiene, 1,3-pentadiene, 1,3-hexadiene, 2,3-dimethylbutadiene, isoprene, piperylene or isoprene, α,β-unsaturated carboxylic acids, such as acrylic acid and methacrylic acid, their esters, in particular alkyl esters such as C₁₋₁₀-alkyl esters of acrylic acid, in particular the butyl esters, preferably n-butyl acrylate, and the C₁₋₁₀-alkyl esters of methacrylic acid, in particular methyl methacrylate (MMA), or carboxamides, for example acrylamide and methacrylamide, as film-forming polymer.

The polymers can, if appropriate, comprise from 1 to 5% by weight of comonomers such as (meth)acrylonitrile, (meth)acrylamide, ureido (meth)acrylate, 2-hydroxyethyl (meth)acrylate, 3-hydroxypropyl (meth)acrylate, acrylamidopropanesulfonic acid, methylolacrylamide or the sodium salt of vinylsulfonic acid.

The film-forming polymer is particularly preferably made up of one or more of the monomers styrene, butadiene, acrylic acid, methacrylic acid, C₁₋₄-alkyl acrylates, C₁₋₄-alkyl methacrylates, acrylamide, methacrylamide and methylol acrylamide.

An infrared-absorbing pigment (IR absorber) such as carbon black, coke, aluminum, graphite or titanium oxide is preferably used in amounts of from 5 to 40% by weight, in particular in amounts of from 10 to 30% by weight, based on the solid of the coating, to reduce the thermal conductivity. The particle size of the IR-absorbing pigment is generally in the range from 0.1 to 100 μm, in particular in the range from 0.5 to 10 μm.

Preference is given to using carbon black having an average primary particle size in the range from 10 to 300 nm, in particular in the range from 30 to 200 nm. The BET surface area is preferably in the range from 10 to 120 m²/g.

As graphite, preference is given to using graphite having an average particle size in the range from 1 to 50 μm.

Furthermore, the coating composition can comprise flame retardants such as expandable graphite, borates, in particular zinc borates, melamin compounds or phosphorus compounds or intumescent compositions which expand, swell or foam at relatively high temperatures, generally from >80 to 100° C., and in the process form an insulating and heat-resistant foam which protects the thermally insulating foam particles underneath from the action of fire and heat.

When flame retardants are used in the polymer coating, it is also possible to achieve sufficient fire protection by means of foam particles which do not contain any flame retardants, in particular not any halogenated flame retardants, or make do with relatively small amounts of flame retardants since the flame retardant in the polymer coating is concentrated on the surface of the foam particles and forms a solid framework under the action of heat or fire.

The coating composition can comprise intumescent compositions which comprise chemically bound water or eliminate water at temperatures above 40° C., e.g. metal hydroxides, metal salt hydrates and metal oxide hydrates, as additional additives.

Suitable metal hydroxides are, in particular, those of groups 2 (alkaline earth metals) and 13 (boron group) of the Periodic Table of the Elements. Preference is given to magnesium hydroxide, aluminum hydroxide and borax. Particular preference is given to aluminum hydroxide.

Suitable metal salt hydrates are all metal salts which have water of crystallization built into their crystal structure. Analogously, suitable metal oxide hydrates are all metal oxides which have water of crystallization built into the crystal structure. Here, the number of water of crystallization molecules per formula unit can be the maximum possible or below this, e.g. copper sulfate pentahydrate, trihydrate or monohydrate. In addition to the water of crystallization, the metal salt hydrates or metal oxide hydrates can also comprise water of constitution.

Preferred metal salt hydrates are the hydrates of metal halides (in particular chlorides), sulfates, carbonates, phosphates, nitrates or borates. Suitable metal salt hydrates are, for example, magnesium sulfate decahydrate, sodium sulfate decahydrate, copper sulfate pentahydrate, nickel sulfate heptahydrate, cobalt(II) chloride hexahydrate, chromium(III) chloride hexahydrate, sodium carbonate decahydrate, magnesium chloride hexahydrate and the tin borate hydrates. Magnesium sulfate decahydrate and tin borate hydrates are particularly preferred.

It is likewise possible to use double salts or alums, for example those of the general formula M^{I}M^{III}(SO₄)₂.12H₂O, as metal salt hydrates. M^{I} can be, for example, potassium, sodium, rubidium, cesium, ammonium, thallium or aluminum ions. M^{III} can be, for example, aluminum, gallium, indium, scandium, titanium, vanadium, chromium, manganese, iron, cobalt, rhodium or iridium.

Suitable metal oxide hydrates are, for example, aluminum oxide hydrate and preferably zinc oxide hydrate or boron trioxide hydrate.

In addition to the clay minerals, further minerals, for example cements, aluminum oxides, vermiculite or perlite, can be additionally added to the coating. These can be introduced into the coating composition in the form of aqueous slurries or dispersions. Cements can also be applied to the foam particles by “dusting”. The water necessary for setting of the cement can then be introduced as steam during sintering.

The coating composition is used, in particular, for coating foam particles.

As foam particles, it is possible to use expanded polyolefins such as expanded polyethylene (EPE) or expanded polypropylene (EPP) or prefoamed particles of expandable styrene polymers, in particular expandable polystyrene (EPS). The foam particles generally have an average particle diameter in the range from 2 to 10 mm. The bulk density of the foam particles is generally from 5 to 100 kg/m³, preferably from 5 to 40 kg/m³ and in particular from 8 to 16 kg/m³, determined in accordance with DIN EN ISO 60.

The foam particles based on styrene polymers can be obtained by prefoaming EPS to the desired density by means of hot air or steam in a prefoamer. Single or multiple prefoaming in a pressure prefoamer or continuous prefoamer enables final bulk densities below 10 g/l to be obtained.

To produce insulating boards having a high thermal conductivity, particular preference is given to using prefoamed, expandable styrene polymers which comprise athermanous solids such as carbon black, aluminum, graphite or titanium dioxide, in particular graphite having an average particle diameter in the range from 1 to 50 μm, in amounts of from 0.1 to 10% by weight, in particular from 2 to 8% by weight, based on EPS, and are known from, for example, EP-B 981 574 and EP-B 981 575.

Furthermore, the foam particles can comprise from 3 to 60% by weight, preferably from 5 to 20% by weight, based on the prefoamed foam particles, of a filler. Possible fillers are organic and inorganic powders or fibrous materials, and also mixtures thereof. As organic fillers, it is possible to use, for example, wood flour, starch, flax, hemp, ramie, jute, sisal, cotton, cellulose or aramid fibers. As inorganic fillers, it is possible to use, for example, carbonates, silicates, barite, glass spheres, zeolites or metal oxides. Preference is given to pulverulent inorganic materials such as talc, chalk, kaolin (Al₂(Si₂O₅)(OH)₄), aluminum hydroxide, magnesium hydroxide, aluminum nitride, aluminum silicate, barium sulfate, calcium carbonate, calcium sulfate, silica, quartz flour, Aerosil®, alumina or wollastonite or spherical or fibrous, inorganic materials such as glass spheres, glass fibers or carbon fibers.

The average particle diameter or in the case of fibrous fillers the length should be in the region of the cell size or smaller. Preference is given to an average particle diameter in the range from 1 to 100 μm, preferably in the range from 2 to 50 μm.

Particular preference is given to inorganic fillers having a density in the range 1.0-4.0 g/cm³, in particular in the range 1.5-3.5 g/cm³. The whiteness/brightness (DIN/ISO) is preferably 50-100%, in particular 60-98%.

The type and amount of fillers can influence the properties of the expandable thermoplastic polymers and the particle foam moldings obtainable therefrom. The use of bonding agents such as styrene copolymers modified with maleic anhydride, polymers comprising epoxide groups, organosilanes or styrene copolymers having isocyanate or acid groups can significantly improve the bonding of the solid to the polymer matrix and thus the mechanical properties of the particle foam moldings.

In general, inorganic fillers reduce the combustibility. The burning behavior can be improved further by, in particular, addition of inorganic powders such as aluminum hydroxide, magnesium hydroxide or borax.

Such filler-comprising foam particles can, for example, be obtained by foaming of filler-comprising, expandable thermoplastic granules. At high filler contents, the expandable granules required for this purpose can be obtained by extrusion of thermoplastic melts comprising blowing agent and subsequent underwater pelletization under pressure, as described in, for example, WO 2005/056653.

The polymer foam particles can additionally be provided with further flame retardants. They can for this purpose comprise, for example, from 1 to 6% by weight of an organic bromine compound such as hexabromocyclododecane (HBCD) and, if appropriate, also from 0.1 to 0.5% by weight of dicumyl or a peroxide in the interior of the foam particles or the coating. However, preference is given to using no halogen-comprising flame retardants.

The coating composition of the invention is preferably applied in the form of an aqueous polymer dispersion together with the clay mineral and the alkali metal silicate and, if appropriate, infrared-absorbing pigments and further additives to the foam particles. Suitable polymer dispersions can be obtained, for example, by free-radical emulsion polymerization of ethylenically unsaturated monomers such as styrene, acrylates or methacrylates, as described in WO 00/50480.

The polymer dispersion is prepared in a manner known per se, for instance by emulsion, suspension or dispersion polymerization, preferably in an aqueous phase. The polymer can also be prepared by solution or bulk polymerization, broken up if appropriate and the polymer particles can subsequently be dispersed in water in a customary fashion. The polymerization is carried out using the initiators, emulsifiers or suspension aids, regulators or other auxiliaries customary for the respective polymerization process and is carried out continuously or batchwise at the temperatures and pressures customary for the respective process in conventional reactors.

The water glass powder comprised in the coating mixture leads to improved or faster film formation from the polymer dispersion and thus to faster curing of the foam molding. If appropriate, hydraulic binders based on cement, lime-cement or gypsum plaster can additionally be added in amounts at which no significant embrittlement of the foam occurs.

To coat the foam particles, it is possible to use customary methods such as spraying, dipping or wetting of the foam particles with/into an aqueous polymer dispersion in customary mixers, spray apparatuses, dipping apparatuses or drum apparatuses.

Furthermore, the foam particles which have been coated according to the invention can additionally be coated with amphiphilic or hydrophobic organic compounds. Coating with hydrophobicizing agents is advantageously carried out before application of the aqueous polymer dispersion according to the invention. Among hydrophobic organic compounds, mention may be made of, in particular, C₁₀-C₃₀ paraffin waxes, reaction products of N-methylolamine and a fatty acid derivative, reaction products of a C₉-C₁₁ oxo alcohol with ethylene oxide, propylene oxide or butylene oxide or polyfluoroalkyl (meth)acrylates or mixtures thereof, which are preferably used in the form of aqueous emulsions.

Preferred hydrophobicizing agents are paraffin waxes which have from 10 to 30 carbon atoms in the carbon chain and preferably have a melting point in the range from 10 to 70° C., in particular from 25 to 60° C. Such paraffin waxes are comprised, for example, in the commercial BASF products RAMASIT KGT, PERSISTOL E and PERSISTOL HP and also in AVERSIN HY-N from Henkel and CEROL ZN from Sandoz.

Another class of suitable hydrophobicizing agents comprises resin-like reaction products of an N-methylolamine with a fatty acid derivative, e.g. a fatty acid amide, fatty amine or fatty alcohol, as are described, for example, in U.S. Pat. No. 2,927,090 or GB-A 475 170. Their melting point is generally in the range from 50 to 90° C. Such resins are comprised, for example, in the commercial BASF product PERSISTOL HP and in ARCOPHOB EFM from Hoechst.

Finally, polyfluoroalkyl (meth)acrylates, for example polyperfluorooctyl acrylate, are also suitable. This substance is comprised in the commercial BASF product PERSISTOL O and in OLEOPHOBOL C from Pfersee.

Further possible coating agents are antistatics such as Emulgator K30 (mixture of secondary sodium alkanesulfonates) or glyceryl stearates such as glyceryl monostearate GMS or glyceryl tristearate. However, customary coating agents, in particular stearates, can be used in reduced amounts or be dispensed with entirely for coating expandable polystyrene in the process of the invention without having an adverse effect on the product quality.

To produce foam moldings, the foam particles provided with the coating according to the invention can be sintered in a mold. Here, the coated foam particles can still be moist or have been dried.

Drying of the polymer dispersion applied to the foam particles can, for example, be carried out in a fluidized bed, paddle dryer or by passing air or nitrogen through a loose bed. A drying time of from 5 minutes to 24 hours, preferably from 30 to 180 minutes, at a temperature in the range from 0 to 80° C., preferably in the range from 30 to 60° C., is generally sufficient for formation of the water-insoluble polymer film.

The water content of the coated foam particles after drying is preferably in the range from 1 to 40% by weight, particularly preferably in the range from 2 to 30% by weight, very particularly preferably in the range from 5 to 15% by weight. It can be determined, for example, by Karl-Fischer titration of the coated foam particles. The weight ratio of foam particles/coating mixture after drying is preferably from 2:1 to 1:10, particularly preferably from 1:1 to 1:5.

The foam particles which have been coated according to the invention can be sintered by means of hot air or steam in customary molds to produce foam moldings.

During sintering or conglutination of the foam particles, the pressure can, for example, be generated by reducing the volume of the mold by means of a movable punch. In general, a pressure in the range from 0.5 to 30 kg/cm² is set here. The mixture of coated foam particles is for this purpose introduced into the opened mold. After closing the mold, the foam particles are pressed by means of the punch, with the air between the foam particles being pushed out and the volume of the interstices being reduced. The foam particles are joined by the polymer coating to form foam moldings.

The bed of particles is preferably compacted to about 50% of the starting volume. In the case of a mold having a cross section of about 1 m², a pressure of from 1 to 5 bar is generally sufficient for this.

The mold is configured according to the desired geometry of the foam body. The degree of fill depends, inter alia, on the desired thickness of the future molding. In the case of foam boards, a simple box-like mold can be used. In the case of complicated geometries in particular, it can be necessary to compact the bed of particles introduced into the mold and in this way eliminate undesirable voids. Compaction can, for example, be achieved by shaking the mold, tumbling motions or other suitable measures.

To accelerate setting, hot air or steam can be injected into the mold or the mold can be heated. However, any heat transfer media such as oil or steam can be used for heating the mold. The hot air or the mold is for this purpose advantageously heated to a temperature in the range from 20 to 120° C., preferably from 30 to 90° C.

As an alternative or in addition, sintering can be carried out continuously or batchwise with injection of microwave energy. Microwaves in the frequency range from 0.85 to 100 GHz, preferably from 0.9 to 10 GHz, and irradiation times in the range from 0.1 to 15 minutes are generally used here. In this way, foam boards having a thickness of more than 5 cm can also be produced.

When hot air or steam at temperatures in the range from 80 to 150° C. or microwave energy is injected, a gauge pressure of from 0.1 to 1.5 bar is usually established, so that the process can also be carried out without external pressure and without a reduction in the volume of the mold. The internal pressure produced by the microwaves or elevated temperatures allows the foam particles to undergo slight further expansion and also fuse together as a result of softening of the foam particles themselves in addition to conglutination via the polymer coating. This results in the interstices between the foam particles disappearing. To accelerate setting, the mold can also be additionally heated as described above by means of a heat transfer medium.

For continuous production of the foam moldings, double belt units as are used for producing polyurethane foams are also suitable. For example, the prefoamed and coated foam particles can be applied continuously to the lowermost of two metal belts, which may have perforations if appropriate, and processed with or without compression due to the metal belts coming together to produce continuous foam boards. In one embodiment of the process, the volume between the two belts is increasingly reduced so that the product between the belts is compressed and the interstices between the foam particles disppear. After a curing zone, a continuous board is obtained. In another embodiment, the volume between the belts can be kept constant and the belts can run through a zone into which hot air or microwaves are introduced and in which the foam particles foam further. Here too, the interstices disappear and a continuous board is obtained. It is also possible to combine the two continuous embodiments of the process.

The thickness, length and width of the foam boards can vary within wide limits and are limited by the size and closure force of the tool. The thickness of the foam boards is usually from 1 to 500 mm, preferably from 10 to 300 mm.

The density of the foam moldings in accordance with DIN 53420 is generally from 10 to 150 kg/m³, preferably from 20 to 90 kg/m³. The process makes it possible to obtain foam moldings having a uniform density over the entire cross section. The density of the outer layers corresponds approximately to the density of the inner regions of the foam molding.

Comminuted foam particles obtained from recycled foam moldings can also be used in the process. It is possible for the foam moldings of the invention to be produced using 100% comminuted recycled foam or proportions of, for example, from 2 to 90% by weight, in particular from 5 to 25% by weight, of comminuted recycled foam together with fresh product without significantly impairing the strength and the mechanical properties.

Further additives such as rubber from old tires or vermiculite can also be added to the coating in order to modify the mechanical and hydraulic properties.

A preferred process comprises the steps:
i) prefoaming of expandable styrene polymers to form foam particles,
ii) application of the coating composition of the invention to the foam particles via an aqueous polymer dispersion,
iii) drying of the polymer dispersion on the foam particles to form a water-insoluble polymer film,
iv) introduction of the foam particles which have been coated with the polymer film into a mold and sintering.

The process is suitable for producing simple or complex foam moldings such as boards, blocks, tubes, rods, profiles, etc. Preference is given to producing boards or blocks which can subsequently be sawn or cut to produce boards. They can be used, for example, in building and construction for the insulation of exterior walls. They are particularly preferably used as core layer for producing sandwich elements, for example structural insulation panels (SIPs) which are used for the construction of coolstores or warehouses.

The clay minerals used according to the invention can easily be dispersed in aqueous polymer dispersions and applied to the prefoamed foam particles. Ceramization by means of the alkali metal silicate occurs only in the case of fire at temperatures above about 500° C. The use of clay minerals such as kaolin in the coating composition does not lead to embrittlement of the foam molding during sintering. The porous ceramic framework structure formed in the case of fire subsequently withstands temperatures above 1000° C.

The foam particles provided with the coating according to the invention can be sintered to form foam moldings which have a high fire resistance value E30, in particular E60, or F30, in particular F60, and even on prolonged application of flames for over 30 or 60 minutes prevent passage of flames, with the structural integrity being maintained by the porous ceramic framework structure formed.

In the construction of coolstores and warehouses, sealing strips are generally used in the joins between the individual sandwich elements (panels). Ideally, the seal should be designed so that the join facing away from the source of heat remains gastight even when the panels are subjected in the case of fire, i.e. under the action of heat, to dimensional changes which in the region of the joins can lead to stresses and consequently movements in different directions in space.

Sealing strips of polyurethanes generally become brittle at about 120° C. If the sealing strip is exposed to hot vapors it becomes brittle and thus loses its sealing properties. The hot gases therefore penetrate through the join and the temperature sensors on the outside are heated as a result.

Preference is given to using sealing strips which have some elasticity even at relatively high temperatures, i.e. when join and strip are heated and “distort”, the strip still seals (remains airtight). As a result, the gases cannot exit at the front. This is demonstrated by, for example, virtually no temperature difference between join and area being observed even after 30 minutes. It is necessary here for the structure to be asymmetric since very high temperatures occur in the interior of the oven within a very short time, whereupon the outer metal sheets of the sandwich elements become detached from the core. This produces large free spaces which immediately make it possible for the gases to get into the interior of the oven.

The sealing strips should not only remain elastic under the action of heat but also be able to “expand further” within certain limits, i.e. have intumescent properties, in order to maintain gastightness in the case of dimensional changes in the region of the join, in particular in the event of cracks being formed. Preference is therefore given to using intumescent sealing strips between the abutting core layers of the sandwich elements, which strips then foam stepwise as the join widens and thus retard the spread of heat and of gas. This measure allows the temperature stress acting on the join facing away from the source of heat to be reduced and the survival time of the “outer join” to be improved significantly.

Foam-like structures or elastic fiber structures which are laid into the joins during construction of the panels and are compressed on final fixing of the panels to the substrate construction are also conceivable. In the case of fire, in particular when the panels are subjected to dimensional changes as a result of the action of heat, this elastic “inlay” can adapt to the altered dimensions in the region of the join and thereby seal it more efficiently. Materials suitable for this purpose are, for example, melamine resin foams (Basotect® from BASF SE), mineral wool strips or a flame-retardant polyethylene foam strip.

The cores can also be provided with a profile, e.g. rabbet or tongue and groove, with integrated tongue or tongue to be inserted, so that the cores intermesh and thereby likewise achieve a better seal.

The geometry of the join is also of importance. Preference is given to “standard joins” having a very large overlap and mechanical stiffness. Suitable methods of sealing the join are tongues and grooves milled from the core material, for example according to the Inta-Lock concept, with a groove which is a number of centimeters deep milled into the core material but a loose tongue which is inserted later on the building site. This can be made of a large number of heat-resistant materials and serves primarily to prevent/reduce exit of gas through the join in the case of fire, even when the core material shrinks somewhat as a result of the action of heat or the panel deforms in the region of the join, which without the inserted tongue would lead to gaping and therefore exit of hot combustion gases in the region of the join.

Suitable materials for the tongue are, for example, regips strips, strips made of silicone or intumescent materials such as expandable graphite or silicates, for example Palusol® or the coating composition according to the invention, mineral fiber wedges, wedges made of melamine resin foams (Basotect®), thin metal strips which can be introduced on each side into a thin groove.

The tongues can, if appropriate, be fixed mechanically by screwing, riveting, etc. Elastic inlays and sealing strips which are laid into the metallic depression of the join profile and swell under the action of heat and seal the joins are also suitable. The elastic inlays in the area were compressed between the abutting end faces of the core material during construction of the panel wall and in the case of fire, if the join gapes, shrinks or deforms as a result of the action of heat, provide a seal within certain limits or at least significantly reduce the outflow of combustion gases.

Possible applications are pallets made of foam as replacement for wooden pallets, cover plates for ceilings, coolboxes, camper vans. Owing to the excellent fire resistance, these are also suitable for air freight.

### EXAMPLES

### Production of the Coating Mixtures

The proportions by weight indicated in table 1 of an acrylate dispersion (Acronal S790, solids content: about 50%) and deionized water (DI water) were added to a mixture of kaolin (Fluka), water glass powder (37% strength, Wöllner) and, if appropriate, titanium dioxide (Kronos 2220) and magnesium hydroxide (95% strength, Fluka) while stirring.

Polystyrene foam particles (density: 10 g/l)

Graphite-comprising, expandable polystyrene (Neopor® 2300 from BASF Aktiengesellschaft) was prefoamed to a density of about 10 g/l in a continuous prefoamer.

### Examples 1-6

The polystyrene foam particles were homogeneously coated with a coating mixture comprising the composition reported in proportions by weight in table 1 in a weight ratio of 1:4 in a mixer. The coated polystyrene foam particles were introduced into an aluminum mold (20 cm×20 cm) and compressed under pressure to 50% of the original volume. The molding was taken from the mold and the thermal conductivity was determined at 20° C. in an ANACON two-plate measuring instrument using a method based on DIN 52612. The volume reduction was determined as a measure of the stability of the ceramized structure after storage at 1050° C. for 5 minutes in a crucible furnace.

The foam moldings of examples 1 to 6 do not drip in the burning test and do not soften back under the action of heat. They are self-extinguishing. The use of titanium dioxide (examples 2-6) in the coating based on water glass powder/kaolin results in a significant reduction in the thermal conductivity compared to example 1.

### Comparative Experiment 1

The procedure of example 1 was repeated using an aqueous water glass solution (Woellner sodium silicate 38/40, solids content: 36%, density: 1.37, molar ratio of SiO₂:Na₂O=3.4) instead of kaolin for the coating.

TABLE 1

| | Ex. 1 | Ex. 2 | Ex. 3 | Ex. 4 | Ex. 5 | Ex. 6 | C1 |
|---|---|---|---|---|---|---|---|
| Coating composition | | | | | | | |
| Water glass powder | 100 | 100 | 100 | 140 | 100 | 60 | 80 |
| Water glass solution | | | | | | | 120 |
| Kaolin | 100 | 100 | 70 | 60 | 100 | 120 | |
| Titanium dioxide | | 20 | 30 | 20 | 20 | 20 | |
| Magnesium hydroxide | | | 10 | | | | |
| Aluminum hydroxide | | | | | | | |
| Acronal ® S 790 | 22 | 22 | 22 | 22 | 22 | 22 | 10 |
| DI water | 80 | 80 | 80 | 80 | 80 | 80 | |
| EPS/coating agent | 1:4 | 1:4 | 1:4 | 1:4 | 1:4 | 1:4 | 1:4 |
| Sintering conditions | | | | | | | |
| Temperature [° C.] | 70 | 70 | 70 | 70 | 70 | 70 | 70 |
| Time [minutes] | 90 | 90 | 90 | 90 | 90 | 120 | 60 |
| Properties | | | | | | | |
| Thermal conductivity | 45 | 41 | 41 | | 41 | | |
| λ [mW/m*K] | | | | | | | |
| Volume decrease [%] | 25 | 15 | 17 | 85 | 15 | | 85 |
| after 5 minutes at | | | | | | | |
| 1050° C. | | | | | | | |

### Comparative Experiment 2

Various amounts corresponding to table 2 of cement mortar (Sakret ZM), Acronal® and water were added to the coating composition of comparative experiment 1 while maintaining the same weights of water glass powder (80 g) and water glass solution (120 g).

The coated polystyrene foam particles were introduced into an aluminum mold (20 cm×20 cm) and compressed under pressure to 50% of the original volume at 70° C. for 60 minutes. Comparative experiments C2l and C2m were not sintered under pressure but were instead after-foamed by means of steam (1 bar) for 20 seconds. The molding was taken from the mold and the thermal conductivity was determined at 20° C. in an ANACON two-plate measuring instrument. The volume reduction after storage at 1050° C. for 5 minutes in a crucible furnace was about 75%. The specimen from comparative experiment C2l had ignited.

TABLE 2

| Comparative | | | | |
|---|---|---|---|---|
| experiment | EPS/cement | Cement [g] | Dispersion [g] | Water [g] |
| C2a | 1:4 | 5 | | 5 |
| C2b | 1:4 | 20 | | 20 |
| C2c | 1:4 | 20 | | 20 |
| C2d | 1:4 | 180 | | 80 |
| C2e | 1:4 | 180 | 10 | 80 |
| C2f | 1:6 | 270 | | 120 |
| C2g | 1:6 | 270 | 10 | 120 |
| C2h | 1:10 | 450 | | 225 |
| C2i | 1:10 | 450 | 10 | 225 |
| C2j | 1:15 | 675 | | 337 |
| C2k | 1:15 | 675 | 50 | 337 |
| C2l | 1:4 | 120 | 60 | |
| C2m | 1:4 | 120 | 30 | |

### Comparative Experiment 3

Various amounts corresponding to table 3 of aluminum hydroxide were added to the coating composition of comparative experiment 1 while maintaining the same weights of water glass powder (80 g), water glass solution (120 g) and Acronal® (10 g).

The coated polystyrene foam particles were introduced into an aluminum mold (20 cm×20 cm) and compressed under pressure to 50% of the original volume at 70° C. for 60 minutes. The molding was taken from the mold and the thermal conductivity was measured at 20° C. in an ANACON two-plate measuring instrument. The volume reduction after storage at 1050° C. for 5 minutes in a crucible furnace was determined.

The specimens from comparative experiments 3a to 3j display very poor matrix stability when they come into direct contact with a flame. The volume reduction after storage at 1050° C. for 5 minutes in a crucible furnace was in all cases above 75%.

TABLE 3

| Comparative | | | | |
|---|---|---|---|---|
| experiment | EPS/cement | Al(OH)₃ [g] | Density [g/l] | λ [mW/m * K] |
| C3a | 1:4 | 10 | 59 | 38 |
| C3b | 1:4 | 20 | 59 | 39 |
| C3c | 1:4 | 30 | 54 | 37 |
| C3d | 1:4 | 40 | 56 | 39 |
| C3e | 1:2 | 5 | 34 | 32 |
| C3f | 1:2 | 10 | 34 | 33 |
| C3g | 1:2 | 15 | 34 | 33 |
| C3h | 1:2 | 20 | 35 | 33 |
| C3i | 1:2 | 30 | 35 | 33 |
| C3j | 1:2 | 40 | 35 | 33 |

1.-13. (canceled)

14. A coating composition comprising
a) from 20 to 70% by weight of a clay mineral,
b) from 20 to 70% by weight of an alkali metal silicate,
c) from 1 to 30% by weight of a film-forming polymer.

15. The coating composition according to claim 14 comprising
a) from 30 to 50% by weight of a clay mineral,
b) from 30 to 50% by weight of an alkali metal silicate,
c) from 5 to 20% by weight of a film-forming polymer,
d) from 5 to 40% by weight of an infrared-absorbing pigment.

16. The coating composition according to claim 14, wherein the weight ratio of clay mineral to alkali metal silicate is in the range from 1:2 to 2:1.

17. The coating composition according to claim 14, wherein the clay mineral comprises allophane Al₂[SiO₅]&O₃.nH₂O, kaolinite Al₄[(OH)₈|Si₄O₁₀], halloysite Al₄[(OH)₈|Si₄O₁₀].2H₂O, montmorillonite (smectite) (Al,Mg,Fe)₂[(OH₂|(Si,Al)₄O₁₀].Na_{0.33}(H₂O)₄, vermiculite Mg₂(Al,Fe,Mg)[(OH₂|(Si,Al)₄O₁₀].Mg_{0.35}(H₂O)₄ or mixtures thereof.

18. The coating composition according to claim 14, wherein the alkali metal silicate comprises a water-soluble alkali metal silicate having the composition M₂O(SiO₂)ₙ where M=sodium or potassium and n=1 to 4 or a mixture thereof.

19. The coating composition according to claim 14 wherein the film-forming polymer comprises an emulsion polymer of ethylenically unsaturated monomers which has a glass transition temperature in the range from −30° to +80° C. as film-forming polymer.

20. Foam particles having the coating according to claim 14.

21. The foam particles according to claim 20 selected from among expanded polyolefin particles or prefoamed particles of expandable styrene polymers (EPS).

22. A process for producing foam moldings, which comprises sintering the foam particles according to claim 20 in a mold.

23. The process according to claim 22 comprising the steps
i) prefoaming of expandable styrene polymers to form foam particles,
ii) application of an aqueous polymer dispersion comprising a coating composition comprising
a) from 20 to 70% by weight of a clay mineral,
b) from 20 to 70% by weight of an alkali metal silicate,
c) from 1 to 30% by weight of a film-forming polymer to the foam particles,
iii) drying of the polymer dispersion on the foam particles to form a water-insoluble polymer film, and
iv) introducing the foam particles which have been coated with the polymer film into a mold and sintering.

24. The process according to claim 22, wherein sintering is carried out under a pressure in the range from 0.5 to 30 kg/cm².

25. The process according to claim 22, wherein sintering is carried out with injection of microwave energy.

26. The process according to claim 22, wherein hot air or steam is injected into the mold.
